(19) United States
(12) Patent Application Publication
(10) Pub. No.: US 2009/0220704 A1
(43) Pub. Date: Sep. 3, 2009

(54) POWDER COATING SYSTEM FOR MDF PANELS

(76) Inventor: BRIAN EUSTACE, Sierra Madre, CA (US)

Correspondence Address: CHRISTIE, PARKER & HALE, LLP, PO BOX 7068, PASADENA, CA, 91109-7068, US

(21) Appl. No.: 12/271,164

(22) Filed: Nov. 14, 2008

Related U.S. Application Data
(60) Provisional application No. 61/003,447, filed on Nov. 16, 2007.

(51) Int. Cl. B05D 1/06; A47G 29/00

(52) U.S. Cl. 427/475; 248/339

(57) ABSTRACT

The present invention provides a process for powder coating shelving panels made of MDF or other particle board materials, peg board panels and other articles made of MDF, peg board or other wood-based products. The process comprises first mounting of the panel on a hanger assembly attachable to an overhead conveyor. The panel is passed through a preheat oven having a temperature of preferably from about 260° F. to about 280° F. for a period of from about 15 minutes to about 30 minutes. The preheated panel preferably having a surface temperature preferably of about 110° F. to 112° F. is then carried through a powder coating booth on a preferred hanger assembly where electrostatically charged particles are sprayed onto the surfaces of the panel.

### CROSS REFERENCE TO RELATED APPLICATION

This application claims priority to U.S. Provisional Patent Application No. 61/003,447, filed Nov. 16, 2007, the entire contents of which are incorporated herein.

### FIELD OF THE INVENTION

The present invention relates to a process and assembly for powder coating shelving panels made of MDF or other particle board materials.

### BACKGROUND

Powder coating is a process in which a fine particles of pigment and resin are electrostatically charged, applied to the surface of a part to be coated and then cured. Curing allows the particles to form a high molecular weight polymeric network-like structure. Powder coating materials may be thermoplastic or thermoset polymers.

In a typical powder coating process work pieces are carried through a powder coating booth on an overhead conveyor and negatively charged particles are sprayed onto a work piece via an electrostatic spray gun. The negative particles will be attracted to the work piece if it is conductive and grounded. Historically, powder coating processes have not been used with non-conductive wood products such as medium density fiberboard (MDF), particle board and the like. It has been found, however, that such products can be made conductive by preheating to draw moisture to the surface. The negatively charged powder particles can thus be attracted to a pre-heated grounded MDF work piece. Once the powder has coated the work piece, the coating is cured e.g., by heating in an infrared oven for time sufficient for the powder to melt and form a polymer network. Certain UV-curable powders can be cured by exposure to ultraviolet light.

One of the design considerations in a powder coating process is how the work piece to be coated is mounted on a conveyor. This is particularly true for large and/or heavy objects such as MDF shelving panels for storage systems. The mounting system must be such that a panel can be easily mounted on the system yet provide assurance that the panel will not dislodge and fall during the process. The mounting system must also minimize any scoring or damage to the exterior surfaces of the work piece.

### SUMMARY OF THE INVENTION

An aspect of an embodiment of the present invention provides a process for powder coating MDF, particle board and peg board panels including: mounting to a panel made of MDF, particle board or peg board onto a hanger assembly of an overhead conveyor; carrying the mounted panel through a preheating oven where the panel is pre-heated at a temperature of from about 260° F. to about 280° F. for a period of from about 15 minutes to about 30 minutes; carrying the preheated mounted panel hangar surface temperature of from about 110° F. to 112° F. through a spray booth where an electrostatically charged powder is sprayed onto the panel to coat the panel; and carrying the coated panel through a curing convection oven at a temperature of from about 300° F. to about 330° F. for a period of from about 30 to about 45 minutes to cure the coating.

Another aspect of an embodiment of the present invention provides a panel and hanger assembly for a powder coating process including: a generally rectangular panel having top and bottom faces, opposing side surfaces and opposing end surfaces; and a blind hole in each side surface adjacent a first end surface, each said blind holes extending from a side surface medially and toward the adjacent end surface, said blind hole having a first diameter; a pair of hangers, each comprising an elongated rod having a second diameter less than the first diameter, each of said rods comprising an elongated upper section and a lower section, the lower section comprising a generally straight end portion having a free end that is received in the blind hole of the panels; and wherein the panel is mounted on the hanger assembly such that, when mounted, the only contact between the end portion of the hanger and the panel is at the upper surface of the free end of the end portion and the lower surface of the end portion adjacent the entrance of the hole.

### BRIEF DESCRIPTION OF THE DRAWINGS

FIG. 1 is a perspective view of a hanger assembly for a shelving panel according to an embodiment of the present invention.

FIG. 2A is a front view of the hanger assembly of FIG. 1.

FIG. 2B is an enlarged view of section A of FIG. 2B.

### DETAILED DESCRIPTION

The present invention provides a process for powder coating shelving panels made of MDF or other particle board materials, peg board panels and other articles made of MDF, peg board or other wood-based products. The process comprises first mounting the work piece on a hanger assembly attachable to an overhead conveyor. The work piece is passed through a preheat oven having a temperature of at least 200° F., and preferably of from about 260° F. to about 280° F., for a period of from about 15 minutes to about 30 minutes. The preheated work piece preferably having a surface temperature of at least about 10° F. to 120° F., and preferably about 105° F. to 115° F. and more preferably about 110° F. to 112° F., is then carried through a powder coating booth where electrostatically charged particles are sprayed onto the surfaces of the work piece. A particularly preferred powder coating material is Max Gray sold by DuPont Powder Coatings, USA. The work piece is then carried through a convection oven where it is heated to a temperature of from about 300° F. to about 330° F., and preferably about 350° F., for a period of from about 30 minutes to about 45 minutes to cure the coating.

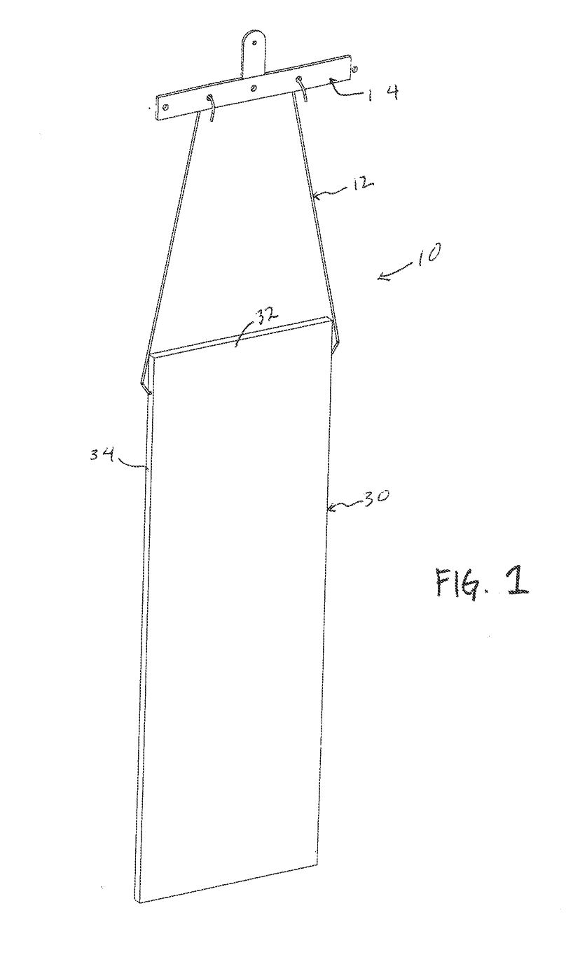

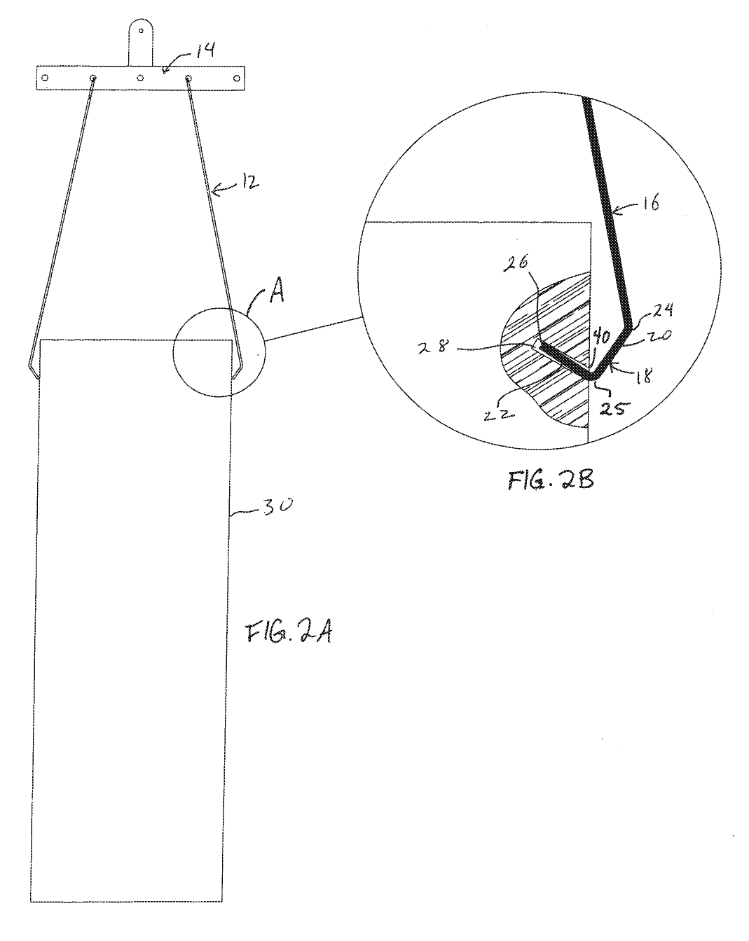

A preferred hanger assembly for a shelving panel 30 is shown in FIGS. 1, 2A, and 2B. The hanger assembly 10 comprises a pair of hanger rods 12 connectable at their upper ends to an overhead conveyor system 14 preferably such that the upper ends of the hanger rod 12 are spaced apart a distance about the same or less than the width of the panel 30. The rods 12 have an elongated upper section 16 and a generally V-shaped lower section 18. The first leg 20 of the V-shaped lower section is connected to and preferably integral with the lower end of the upper section forming an obtuse angle of from about 0° to about 90° and preferably from about 15° to about 45°. The second leg 22 of the V-shaped lower section has a connected end at bend 25 and a free end 26. The angle between the first and second leg is preferably from about 45° to about 135°, and preferably about 90°.

The free end 26 of the second leg is received in a blind hole 28 in a side surface of the panel 30 to be coated. Preferred panels are made of MDF and preferably have a thickness of at least ½ inch, and more preferably at least about ⅝ inch. Each blind hole 28 is adjacent to the top end 32 of the panel 30 when it is hung in the conveyor system. Each blind hole 28 extends medially inwardly and upwardly from the panel's generally vertical side surfaces 34, preferably at an angle of from about 15° to about 85°, e.g., 45°. The diameter of the hole 28 is greater than the diameter of the hanger rods 12. The angles are chosen so that the hanger contacts the panel in two places only: (1) at the upper edge of the free inner end 26 of the second leg 22 of the lower section 18 and (2) at the lower outer surface of the bend 25 between the first and second legs 20 and 22 of the lower section 18 as shown in FIG. 26. This arrangement protects the inside corner 40 created by the blind hole 28.

Preferably each hanger rod is made of a single piece of metal rod having a first bend 24 at the transition of the upper section 16 and the first leg 20 of the lower section 18. A second bend 25 is present at the transition of the first and second legs 20 and 22 of the lower section 18. When a panel is mounted on the hanger assembly, the bends 24 and 25 flex but still maintain contact with the panel 30 as shown in FIG. 2b.

It is understood that every design of the hanger which avoids unwanted contact with the panel surfaces and includes a generally straight lower free end that can be received in the blind hole may be used as desired.

For peg board panels, hanger rods that include a free lower end that can be inserted onto and through holes in the peg board and which carry the peg board in a generally vertical orientation are preferred.

1. A process for powder coating MDF, particle board and peg board panels comprising:
mounting to a panel made of MDF, particle board or peg board onto a hanger assembly of an overhead conveyor;
carrying the mounted panel through a preheating oven where the panel is pre-heated at a temperature of from about 260° F. to about 280° F. for a period of from about 15 minutes to about 30 minutes;
carrying the preheated mounted panel hangar surface temperature of from about 110° F. to 112° F. through a spray booth where an electrostatically charged powder is sprayed onto the panel to coat the panel; and
carrying the coated panel through a curing convection oven at a temperature of from about 300° F. to about 330° F. for a period of from about 30 to about 45 minutes to cure the coating.

2. A panel and hanger assembly for a powder coating process comprising:
a generally rectangular panel having top and bottom faces, opposing side surfaces and opposing end surfaces; and a blind hole in each side surface adjacent a first end surface, each said blind holes extending from a side surface medially and toward the adjacent end surface, said blind hole having a first diameter;
a pair of hangers, each comprising an elongated rod having a second diameter less than the first diameter, each of said rods comprising an elongated upper section and a lower section, the lower section comprising a generally straight end portion having a free end that is received in the blind hole of the panels; and
wherein the panel is mounted on the hanger assembly such that, when mounted, the only contact between the end portion of the hanger and the panel is at the upper surface of the free end of the end portion and the lower surface of the end portion adjacent the entrance of the hole.
